(19) United States
(12) Patent Application Publication
(10) Pub. No.: US 2006/0197255 A1
(43) Pub. Date: Sep. 7, 2006

(54) Dope estimation method and solution casting method

(75) Inventor: Tadahiro Tsujimoto, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/364,341

(22) Filed: Mar. 1, 2006

(30) Foreign Application Priority Data
Mar. 1, 2005 (JP) 2005-055344

(51) Int. Cl. B29D 7/00

(52) U.S. Cl. 264/216; 73/863; 264/40.1

(57) ABSTRACT

A polymer solution is obtained by cooling and heating a mixture of polymer and solvent. Then a filtration of the polymer solution is continuously performed. Then after the polymer solution is stored in the stock tank for two weeks, a second filtration of the polymer solution is continuously performed. In each filtration, an initial filtration pressure is 0.1 MPa. Until the filtration pressure becomes 1 MPa, the filtration quantity per unit size of a filter material is t1 (m³) in the first filtration and t2 (m³) in the second filtration. The flow rate of the polymer solution is controlled such that a value t2/t1 may be at least 0.5.

### BACKGROUND OF THE INVENTION

1. Field of the Invention

The present invention relates to a dope estimation method and a solution casting method, and especially to a dope estimation method used for a solution casting method and a solution casting method for producing a film to be used for an optical functional film, such as a protective film for a polarizing filter, a wide view film and the like.

2. Description Related to the Prior Art

A cellulose acylate film is formed from cellulose acylate. For example, a cellulose triacetate (hereinafter TAC) film is formed from the TAC in which averaged acetylation degree is 57.5% to 62.5%, and used as a film support for an optical sensitive materials because of the strength and inflammability. Further, the TAC film is excellent in the optical isotropy, and therefore the TAC film is used as a protective film for a polarizing filter, or an optical compensation film (for example, a wide view film) and the like in a liquid crystal display while a market of these sorts of the optical films is extended recently.

The TAC film is usually produced by a solution casting method, in which the produced film is more excellent in physical properties such as optical properties and the like than other film production method such as a melt extrusion method and the like. When it is designated to perform the solution casting method, polymer is dissolved in a mixture solvent in which dichloromethane or methyl acylate is the main solvent component, so as to prepare a polymer solution (hereinafter, dope). The dope is cast onto a support by a casting die so as to form a casting film. When the casting film has a self-supporting property, the casting film is peeled as a wet film from the support and dried to be a film. Thereafter the film is wound up. (cf: Japan Institute of Invention and Innovation (JIII) Journal of Technical Disclosure No. 2001-1745)

In the solution casting method, it is extremely important for designing the quality of the film, to know whether there are foreign materials in the film produced by the solution casting. Especially, in recent years, according to the optical functional film to be used in the liquid crystal display and the like, the high quality of the film is required. However, the foreign materials and the nonuniformity of the optical property of the film easily decreases the quality of the optical film. Especially, in the solution casting process, the foreign materials adhere to the film and therefore the fluctuation of the optical property occurs. The easiness of adhesion and the fluctuation of the optical property are depending on the quality of the dope.

If the foreign materials are removed from the dope, the produced film can have the enough quality. Namely, the quality of the dope can be estimated on the basis of the transparency and the flowability of the dope prepared for the casting. However, even if the quality of the dope is kept, it is hard to always produce the film of the uniform optical property in which there are only little foreign materials.

### SUMMARY OF THE INVENTION

An object of the present invention is to provide a dope estimation method by which the estimation whether the film of the high quality is to be produced is made before the film production.

Another object of the present invention is to provide a solution casting method for producing the film excellent in the optical property.

In order to achieve the object and the other object, in an estimation method of a dope to be used for a solution casing method, a first filtration of the dope containing polymer and solvent is performed with a first filter having an averaged nominal diameter in the range of 5 μm to 50 μm. A flow rate of the dope is decided such that initial filtration pressure may be 0.1 MPa. In the first filtration, a filtration quantity t1 (m³) of the dope through a unit size of the first filter until filtration pressure becomes 1 MPa. Then the dope is stored in a vessel for two weeks after said first filtration. After the storage, a second filtration of the dope is performed with a second filter having the same averaged nominal diameter as the first filter. A flow rate of the dope is decided such that initial filtration pressure may be 0.1 MPa. In the second filtration, a filtration quantity t2 (m³) of the dope through a unit size of the second filter is measured until filtration pressure becomes 1 MPa. The dope satisfying that a value t2/t1 is at least 0.5 is used for the solution casting method.

In a preferable estimation method, a third filtration is made by feeding the dope through a third filter, before the first filtration. Further, preferably, when a viscosity of said dope is described as V1 (Pa·s) in said first filtration and V2 (Pa·s) in said second filtration, a viscosity ratio V1/V2 is at least 0.8. Preferably, the polymer is cellulose acylate. Further, the solvent preferably contains methyl citrate.

In a preferable embodiment of an estimation method of a dope to be used for a solution casing method, the dope contains polymer and solvent. A first filtration of the dope is performed with a first filter having an averaged nominal diameter in the range of 5 μm to 50 μm. A flow rate of the dope is decided such that initial filtration pressure may be 0.1 MPa. Then the dope is stored in a vessel for two weeks after said first filtration. After the storage, a second filtration of the dope is performed with a second filter having the same averaged nominal diameter as the first filter. A flow rate of the dope is decided such that initial filtration pressure may be 0.1 MPa. When a viscosity of said dope is described as V1 (Pa·s) in said first filtration and V2 (Pa·s) in said second filtration, a viscosity ratio V1/V2 is at least 0.8.

Preferably, the polymer is cellulose acylate, and the solvent contains methyl citrate in a solution casting method of the present invention, a dope containing polymer and solvent is used. A first filtration of the dope is performed with a first filter having an averaged nominal diameter in the range of 5 μm to 50 μm. A flow rate of the dope is decided =3 such that initial filtration pressure may be 0.1 MPa. In the first filtration, a filtration quantity t1 (m³) of the dope through a unit size of the first filter until filtration pressure becomes 1 MPa. Then the dope is stored in a vessel for two weeks after said first filtration. After the storage, a second filtration of the dope is performed with a second filter having the same averaged nominal diameter as the first filter. A flow rate of the dope is decided such that initial filtration pressure may be 0.1 MPa. In the second filtration, a filtration quantity t2 (m³) of the dope through a unit size of the second filter is measured until filtration pressure becomes 1 MPa. The dope satisfying that a value t2/t1 is at least 0.5 is cast onto a support.

In a preferable solution casting method, a third filtration is made by feeding the dope through a third filter, before the first filtration. Particularly preferably, a fourth filtration with use of a fourth filter is made between the third filtration and the first filtration. One of filter materials of the third and fourth filters is filter paper or non-woven cloth and another one is metallic filter material. When the averaged nominal diameter is described as P1 (μm) for the third filter and P2 (μm) for the first filter, a condition P1≦0.7×P2 is satisfied.

Preferably, in the solution casting method, the fourth filtration is made between the third filtration and the first filtration, and the dope is concentrated between the third filtration and the fourth filtration. Preferably, a filter aid is used in at least one of the third filtration and the fourth filtration. The polymer is cellulose acylate, and the solvent contains methyl acylate. Preferably, when a viscosity of said dope is described as V1 (Pa·s) in the first filtration and V2 (Pa·s) in the second filtration, a viscosity ratio V1/V2 is at least 0.8.

In a preferable embodiment of a solution casting method of the present invention, a dope containing polymer and solvent is used. A first filtration of the dope is performed with a first filter having an averaged nominal diameter in the range of 5 μm to 50 μm. A flow rate of the dope is decided such that initial filtration pressure may be 0.1 MPa. Then the dope is stored in a vessel for two weeks after said first filtration. After the storage, a second filtration of the dope is performed with a second filter having the same averaged nominal diameter as the first filter. A flow rate of the dope is decided such that initial filtration pressure may be 0.1 MPa. When a viscosity of said dope is described as V1 (Pa·s) in said first filtration and V2 (Pa·s) in said second filtration, the dope satisfying that a viscosity ratio V1/V2 is at least 0.8 is cast onto a support.

In a preferable solution casting method, a third filtration is made by feeding the dope through a third filter, before the first filtration. Particularly preferably, the third filter is filter paper or non-woven cloth and the first filter is metallic filter material.

Preferably, in the solution casting method, the dope is concented between the third filtration and the first filtration. Preferably, a filter aid is used in the third filtration or the first filtration. The polymer is cellulose acylate, and the solvent contains methyl acylate. Preferably, the solvent contains methyl citrate.

According to the estimation method of the present invention, the optical property of the film to be produced by the solution casting method is excellent when the ratio of the filtration quantity (t2/t1) is at least 0.5.

Further, the third filtration is made before the first filtration. Therefore, the optical property of the film to be produced by the solution casting method is excellent when the ratio of the filtration quantity (t2/t1) is at least 0.5.

According to the estimation method of the present invention, a viscosity of said dope is described as V1 (Pa·s) in said first filtration and V2 (Pa·s) in said second filtration. In this case, the film excellent in optical properties is produced from the dope satisfying that a viscosity ratio V1/V2 is at least 0.8 is used for the solution casting method, when a viscosity of said dope is described as V1 (Pa·s) in said first filtration and V2 (Pa·s) in said second filtration.

According to the estimation method of the present invention, the third filtration is made before the first filtration. Further, the film excellent in optical properties is produced from the dope when the ratio of the filtration quantity t2/t1 is at least 0.5 and the viscosity ratio V1/V2 is at least 0.8.

According to the solution casting method of the present invention, the ratio of the filtration quantity (t2/t1) is at least 0.5. In this case, since undissolved particles are prevented from increasing to large particles during the storage of the dope, the film excellent in the optical properties is produced.

Further, the third filtration is made before the first filtration, and the ratio of the filtration quantity (t2/t1) is at least 0.5. Thus undissolved particles are prevented from increasing to large particles during the storage of the dope. Therefore, the film excellent in the optical properties is produced.

According to the solution casting method of the present invention, a viscosity of said dope is described as V1 (Pa·s) in said first filtration and V2 (Pa·s) in said second filtration and the ratio of the filtration quantity (t2/t1) is at least 0.5. Thus undissolved particles are prevented from increasing to large particles during the storage of the dope. Therefore, the film excellent in the optical properties is produced.

According to the solution casting method of the present invention, the third filtration is made before the first filtration. Further, the film excellent in optical properties is produced from the dope when the ratio of the filtration quantity t2/t1 is at least 0.5 and the viscosity ratio V1/V2 is at least 0.8. Thus undissolved particles are prevented from increasing to large particles during the storage of the dope. Therefore, the film excellent in the optical properties is produced.

According to the solution casting method of the present invention, the third filtration is made before the first filtration. Further, one of filter materials of the third and fourth filters is filter paper or non-woven cloth and another one is metallic filter material. When the averaged nominal diameter is described as P1 (μm) for the third filter and P2 (μm) for the first filter, a condition P1≦0.7×P2 is satisfied. Thus undissolved particles are prevented from increasing to large particles during the storage of the dope. Therefore, the film excellent in the optical properties is produced.

As a result of the consideration of the inventor, the inventor found followings. The polymer solution to be used for the solution casting method to form the polymer solution whose optical properties becomes higher and lower depending on the properties after the preparation and the property variations after a predetermined period. Further, in the storage and a feed of the polymer solution, when the undissolved particles and gel cores are trapped by the filtration, the polymer solution stability for the predetermined period becomes extremely higher. Furthermore, in order to obtain a high quality film in the solution casting method, the polymer solution stability for the predetermined period is important and must be a predetermined level.

The polymer solution stability for the predetermined period is determined to that a flowability and a transparency of the polymer solution are kept to be at least the predetermined values and a filterability doesn't become worse.

In this point, the inventor further found the followings, the retention of the polymer solution during the storage and feed in the processes occurs during the storage and feed of the polymer solution, and then the undissolved materials in the polymer solution and the undissolvent particles (such as gel materials) are cores to be larger to coarse particles. This is the reason why the flowability and the transparency becomes lower than the predetermined value and the filterability becomes worse.

Therefore, in order to prevent this phenomena in the film production, it is necessary that the polymer solution stability for the predetermined period is determined to that a flowability and a transparency of the polymer solution are kept to be at least the predetermined values and a filterability doesn't become worse. If the undissolved particles in the polymer solution is removed before the storage, the generation of the coarse particles from the undissolved particles as cores is prevented, and thus the polymer solution stability for the predetermined period becomes larger. Further, if the viscosity of the polymer solution is reduced, the generation of the coarse particles is also prevented. As the result, the generation of the streak is prevented and the contain of the foreign materials in the film is also prevented.

The quantitative estimation of the remove of the undissolved particles can be made by a method of optical scattering. However, the inventor found that the estimation can be made with high accuracy by evaluation of the filtration longevity in the quantitative filtration with use of a predetermined filter material. The filtration of the polymer solution is made by feeding a predetermined amount of the polymer solution through a filter material, for example filter paper, non-woven cloth or metal filter material. Then the difference of the filtration pressure is compared. Otherwise, until the filtration pressure becomes to a predetermined value, the filtration quantity of the filtrated polymer solution is compared. Otherwise, in the case of the filtration of the polymer solution, the approximation of the standard clogging filtration system is usually applied. Therefore, the least square approximation is applied to the model formula to obtain a curve of filtration pressure difference.

The inventor found in the present invention that the generation of the undissolved particles doesn't have any influence of the film quality if the variations of the filtration pressure and the viscosity after the storage for two weeks are controlled in a predetermined range. Further, the predetermined value is 15×T if T is determined as the storage tome of the dope between the preparation and the casting.

### BRIEF DESCRIPTION OF THE DRAWINGS

The above objects and advantages of the present invention will become easily understood by one of ordinary skill in the art when the following detailed description would be read in connection with the accompanying drawings.

FIG. 1 is a flow chart of processes in a solution casting method of the present invention;

FIG. 2 is a schematic diagram of a dope production line for performing the solution casting method of the present invention;

FIG. 3 is a schematic diagram of a film production line for performing the solution casting method of the present invention.

### PREFERRED EMBODIMENTS OF THE INVENTION

[Raw Materials]

As for cellulose acylate, it is preferable that the degree of substitution of acyl groups for hydrogen atoms on hydroxyl groups of cellulose preferably satisfies all of following formulae (I)-(III).
2.5≦A+B≦3.0 (I)
0≦A≦3.0 (II)
0≦B≦2.9 (III)

In these formulae (I)-(III), A is the degree of substitution of the acetyl groups for the hydrogen atoms on the hydroxyl groups of cellulose, and B is the degree of substitution of the acyl groups for the hydrogen atoms while each acyl group has carbon atoms whose number is from 3 to 22. Note that at least 90 wt. % of TAC is particles having diameters from 0.1 mm to 4 mm.

As solvents for preparing the dope, there are aromatic hydrocarbons (for example, benzene, toluene and the like), hydrocarbon halides (for example, dichloromethane, chlorobenzene and the like), alcohols (for example, methanol, ethanol, n-propanol, n-butanol, diethyleneglycol and the like), ketones (for example, acetone, methylethyl ketone and the like), esters (for example, methyl acetate, ethyl acetate, propyl acetate and the like), ethers (for example, tetrahydrofuran, methylcellosolve and the like) and the like.

The solvents are preferably hydrocarbon halides having 1 to 7 carbon atoms, and especially dichloromethane. Then in view of the solubility of cellulose acylate, the peelability of a casting film from a support, a mechanical strength of a film, optical properties of the film and the like, it is preferable that one or several sorts of alcohols having 1 to 5 carbon atoms is mixed with dichloromethane. Thereat the content of the alcohols to the entire solvent is preferably in the range of 2 mass % to 25 mass %, and particularly in the range of 5 mass % to 20 mass %. Concretely, there are methanol, ethanol, n-propanol, iso-propanol, n-butanol and the like. The preferable examples for the alcohols are methanol, ethanol, n-butanol, or a mixture thereof.

By the way, recent1 y in order to reduce the effect to the environment to the minimum, the solvent composition when dichloromethane is not used is progressively considered. In order to achieve this object, ethers having 4 to 12 carbon atoms, ketones having 3 to 12 carbon atoms, esters having 3 to 12 esters are preferable, and a mixture thereof can be used. These ethers, ketones and esters may have the ring structure. Further, the compounds having at least two of functional groups in ethers, ketones and esters (namely, —O—, —CO— and —COO—) can be used for the solvent. Further, the solvent may have other functional groups, such as alcoholic hydroxyl groups, in the chemical structure.

The detail explanation of cellulose acylate is made from [0140] to [0195] in Japanese Patent Laid-Open Publication No. 2005-104148. The description of this publication is also applied to the present invention. Further, there are for the additive several additive materials (such as the solvent, plasticizer, deterioration inhibitor, UV absorbing agent, optically anisotropic controller, retardation controller, dyne, matting agent, release agent, releasing accelerator and the like), which are described in detail from [0196] to [0516] of Japanese Patent Laid-Open Publication No. 2005-104148.

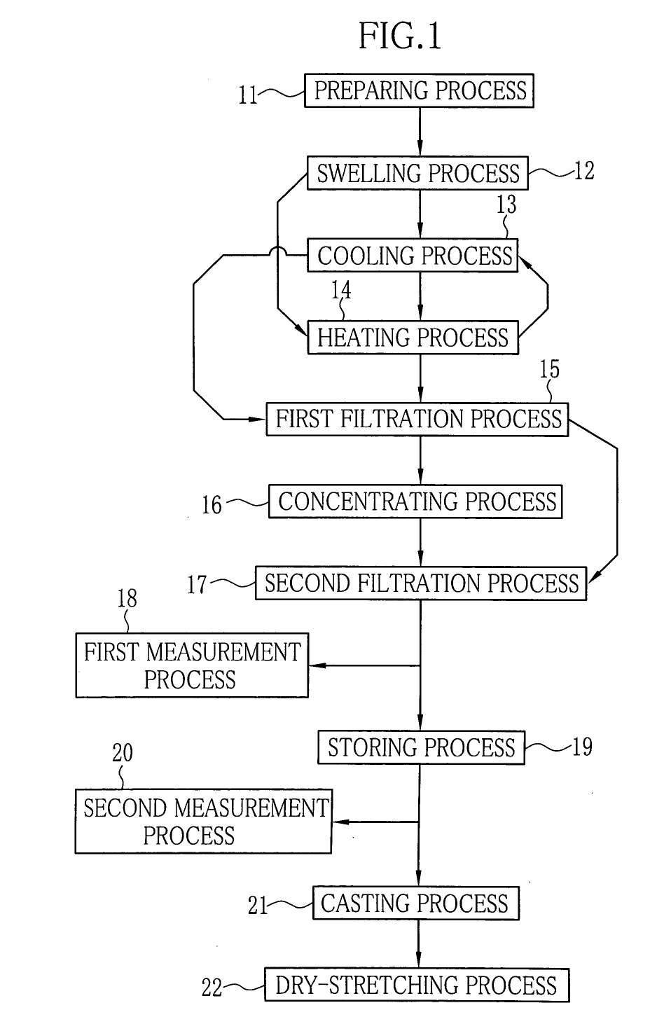

In the solution casting method, as shown in FIG. 1, a preparing process 11, a swelling process 12, a cooling process 13, a heating process 14, a first filtration process 15, a concentrating process 16, a second filtration process 17, a first measurement process 18 and a storing process 19 are performed for producing the dope. Thereafter, a second measurement process 20, a casting process 21 and a dry-stretching process 22 are performed, and thus the film is obtained. The pressure measurement process according to the present invention can be made in other manners than the above description, for example, after the completion of the cooling process 13 and the storing process 19.

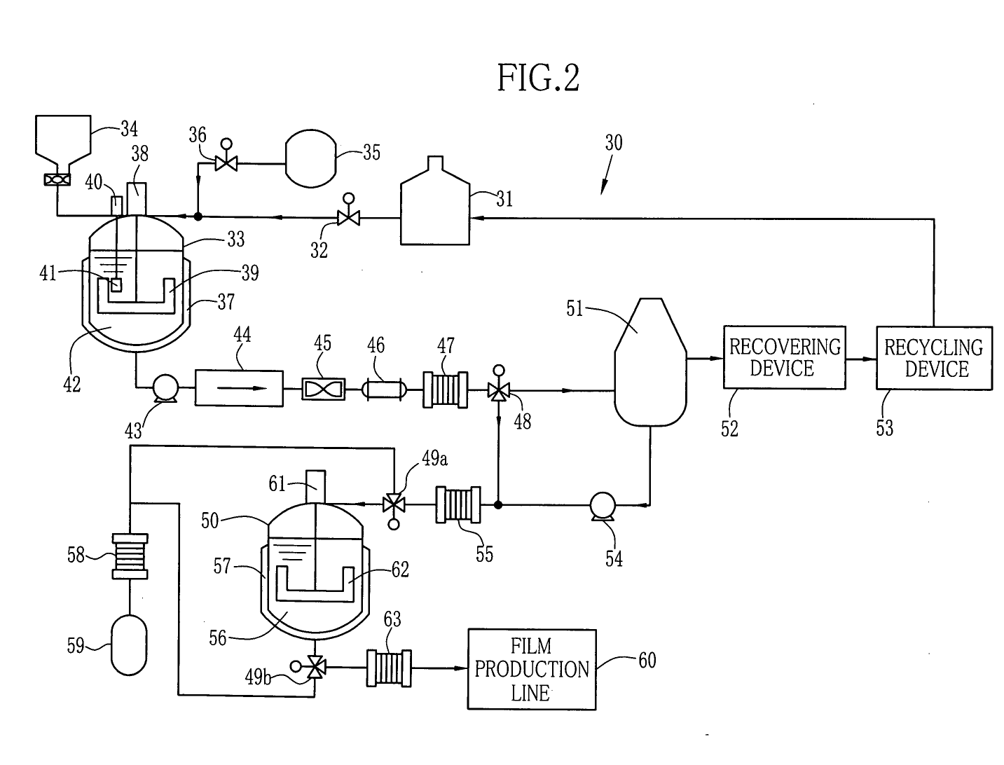

As shown in FIG. 2, the preparing process 11, the swelling process 12, the cooling process 13, the heating process 14, the first filtration process 15, the concentrating process 16 and the second filtration process 17 of FIG. 1 are performed in a dope production line 30.

The preparing process 11 are provided with a solvent tank 31 containing a solvent, a hopper 34 for feeding TAC, an additive tank 35 containing a solution of an additive (hereinafter additive solution), and valves 32, 36. When the valve 32 is opened, the solvent is sent to a dissolution tank 33 of the swelling process 12. Then a necessary amount of TAC in the hopper 34 is sent with measuring to the dissolution tank 33. By opening and closing the valve 36, a necessary amount of the additive solution is sent from the additive tank 35 to the dissolution tank 33. Note that if the additive is in the liquid state in the room temperature, it may be fed in the liquid state to the dissolution tank 33 without preparing the additive solution. Otherwise, if the additive is in the solid state in the room temperature, it may be fed in the solid state to the dissolution tank 33 with use of a hopper. If plural sorts of additive compounds are used, the additive containing the plural additive compounds may be accumulated in the additive tank 35 altogether. Otherwise plural additive tanks may be used so as to contain the respective additive compounds, which are sent through independent pipes to the dissolution tank 33.

In the above explanation, the solvent (which may contain plural solvent compounds), TAC, the additive are sequentially sent to the dissolution tank 33. However, the sending order is not restricted in it. For example, after the necessary amount of TAC is sent with measurement to the dissolution tank 33, the feeding of the preferable amount of the solvent may be performed. Further, it is not necessary that the additive are previously sent in the dissolution tank 33, and they may be added to a mixture of TAC and the solvent.

The dissolution tank 33 of the swelling process 12 is provided with a jacket 37 covering over an outer surface of the dissolution tank 33, a first stirrer 39 to be rotated by a motor 38, and a second stirrer 41 to be rotated by a motor 40. The first stirrer 39 preferably has an anchor blade, and the second stirrer 41 is preferably an eccentric stirrer of a dissolver type. The inner temperature in the dissolution tank 33 is controlled with use of the heat transferring medium flowing in the jacket 37. The preferable inner temperature is in the range of −10° C. to 55° C. At least one of the first and second stirrers 39, 41 is adequately chosen for performing the rotation. Thus a swelling liquid 42 in which TAC is swollen in the solvent is obtained. Note that the second stirrer 41 may be omitted. However, as in this embodiment, the second stirrer 41 is preferably provided.

The swelling liquid 42 is fed to a cooling device 44 in the cooling process 13 by a pump 43. Preferably, the cooling device 44 is provided with an extruder having a screw. The screw is provided with a jacket in which a cooling medium flows. The cooling medium is preferably brine (Registered Trademark), florinate (Registered Trademark) and the like. The cooling temperature is not restricted especially. However, it is preferably in the range of −100° C. to −10° C. The swelling liquid 42 has high viscosity, and thus is inferior in the flowability. Therefore, when the shearing is applied to the swelling liquid 42 with the screw at high shear rate (for example in the range of 1 per second to 1000 per second), the polymer as the solute can easily dissolve to the solvent. Note that the mixing is performed under the atmospheric pressure with a static mixer 45 after the cooling process 13, such that the solubility may be increased. Note that the cooling device is not restricted in the extruder having a screw used in the cooling process 13. For example, a device in which a pipe having jacket and a feed pump are combined may be used as the cooling device.

Then the swelling liquid 42 in which the dissolution proceeds is fed to a heating device 46 in the heating process 14. The heating device 46 is preferably a pipe with a jacket, and further has a structure so as to pressurize the swelling liquid 42. In the heating process 14, the heating or the press-heating of the swelling liquid 42 is performed, and thus the dissolution of the swollen solid material in the swelling liquid 42 proceeds such that a polymer solution may be obtained. In this case, the temperature of the swelling liquid 42 is preferably in the range of 0° C. to 97° C. It is to be noted in the dope production that the heating process 14 may be performed after the swelling process 12 and the cooling process 13 may be performed after the heating process 14. Furthermore, the dissolubility is increased by repeating the cooling process 13 and the heating process 14.

After performing the cooling process 13 and the heating process 14, the swelling liquid 42 is fed as polymer solution. Then, in the first filtration process 15, the trapping of undissolved particles, foreign materials and the like from the polymer solution is made with a filtration device 47. The filter material of the filtration device 47 is not restricted especially. However, it is preferably filter paper or non-woven cloth. The filter material can effectively remove the impurities contained in cellulose as raw material of TAC. Further, an averaged nominal diameter P1(μm)of the filter material is not restricted especially. However, it is preferably in the range of 1 μm to 100 μm, and particularly in the range of 5 μm to 50 μm. The flow rate of the filtration in the filtration device 47 is preferably in the range of 50 liter/hr to 5000 liter/hr.

The polymer solution can be used as a dope for a film production, which will be explained. However, in the method in which the dissolution of TAC is performed after the preparation of the swelling liquid, if it is designated that a polymer solution of high concentration is produced, the time for production of such dope becomes longer. Consequently, the production cost becomes higher. Therefore, it is preferable that a polymer solution of the lower concentration than the predetermined value is prepared at first and then the concentrating of the polymer solution is made. In this embodiment, the polymer solution after the filtration is sent to a flushing device 51 through a valve 48. In the flushing device 51, the solvent of the polymer solution is partially evaporated. The solvent vapor generated in the evaporation is condensed by a condenser (not shown) to a liquid state, and recovered by a recovering device 52. The recovered solvent is recycled by a recycling device 53 and reused. According to this method, the decrease of cost can be designated, since the production efficiency becomes higher and the solvent is reused.

The concentrated polymer solution is drawn out from the flushing device 51 with use of a pump 54. It is thereafter preferable to make the defoaming from the polymer solution. The defoaming may be performed in any known methods, for example in ultrasonic wave irradiation method. Thereafter, the polymer solution is fed to a filtration device 55 so as to perform the second filtration process 17. Thus the foreign materials are removed from the polymer solution by the filtration device 55. The filter material of the filtration device 55 is not restricted especially. However, it is preferably made of metal (for example, stainless, nitriding steel, Hasteroy and the like). If the used filter material is metal, the life of the filter material becomes longer. Therefore, the exchange frequency of the filter material becomes lower, and the productivity becomes higher.

Further, an averaged nominal diameter P2 (μm) of the filter material is in the range of 5 μm to 50 μm. Further, according to the averaged nominal diameter between the first filtration process 15 and the second filtration process 17, it is preferable that the values P1 and P2 satisfy the following formula: P1≦0.7×P2. In the filtration with use of the filtration device 47, the temperature of the polymer solution is preferably in the range of 0° C. to 200° C. Further, the polymer solution is fed to the stock tank 50.

Preferably, filter aid is used to one of the filtration devices 47 and 55. Especially, the filter aid is used to the upstream one, namely the filtration device 47. If the filter aid is used, the undissolved micro particles and the gel-like materials are adsorbed or included. Thus the filtration resistance can be decreased and the clogging of the filter material can be reduced. In the present invention, the filter aid is not restricted especially. However, the preferable filter aid is diatom earth, perlite, cellulose and the like. The especially preferable filter aid is diatom earth.

In the present invention, it is to be noted that the concentrating process 16 in which the flushing device 51 is used can be omitted. In this case, in order to perform the second filtration process 17, the position of the stopcock of the valve (or three-way valve) 48 is adjusted such that the polymer solution may be fed to the filtration device 55.

In the above method, the TAC concentration of the produced polymer solution can be controlled in the range of 5 mass % to 40 mass %. The polymer solution is fed and stored as a polymer solution 56 in the stock tank 50, such that the storing process 19 may be performed. In the stock tank 50, a stirrer 62 is rotated in the polymer solution 56 by a motor 61 so as to make the defoaming of the polymer solution 56. In the performance of the process 21 and the dry-stretching process 22, if the polymer solution 56 would contain the gas materials, the gas wound be generated from the polymer solution 56, and thus the surface condition of the film would become bad. However, in the present invention, the occurrence of this phenomenon can be prevented. Furthermore, since the polymer solution 56 is always stirred, the growth of the coarse particles from the undissolved micro particles as cores can be prevented.

In order to prevent the growth for the coarse articles, the temperature control of the polymer solution 56 is the most effective. A jacket 57 is attached to the stock tank 50, and a heating medium is supplied into the jacket 57. Thus the temperature of the polymer solution 56 is controlled to the predetermined value. As the preferable heating medium, there are water, silicon oil, mineral oil and the like. Further, when the main solvent of the polymer solution 56 is methyl acetate, the temperature is preferably in the range of 20° C. to 50° C. When the main solvent is dichloromethane, the temperature is preferably in the range of 20° C. to 40° C.

Then, the first measurement process 18 is performed so as to measure the filtration pressure of the filtrated polymer solution 56 with use of a filtration device 58 in which absolute nominal diameter of a filter material is in the range of 5 μm to 50 μm. Note that the filtration device 58 may be the same as one of the filtration devices 47, 55. In order to make the first measurement process 18, a three dimensional valve 49a disposed between the filtering apparatus 55 and the stock tank 50 is driven so as to feed part of the polymer solution 56 to the filtration device 58. The flow rate is determined (for example, from 0.001 m³/min to 0.1 m³/min) such that an upstream side filtration pressure may be 0.1 MPa. Thereafter, the filtration of the polymer solution 56 is continuously made, and then a total filtration quantity of the extracted part of the polymer solution 56 is measured until the filtration pressure becomes 1 MPa. The filtration quantity of the polymer solution 56 per unit size of the filter material can be calculated from the measured total filtration quantity, and described as t1 (m³). Further, the viscosity of the polymer solution before the storing process 19 is measured at 25° C. with capillary rheometer and described as V1(Pa·s). Note that the part of the polymer solution 56 after the-filtration of the filtration device 58 is fed to a tank 59, and may be supplied back to the storing tank 50.

After the storage for two weeks, the second measurement process 20 is performed so as to measure the filtration pressure of the filtrated polymer solution 56 with use of the filtration device 58. In order to make the second measurement process 20, a three dimensional valve 49b disposed between the stock tank 50 and the filtering device 63 is driven so as to feed the polymer solution 56 to the filtration device 58. The flow rate is determined (for example, from 0.001 m³/min to 0.1 m³/min) such that an initial filtration pressure may be 0.1 MPa. Thereafter, the filtration of the polymer solution 56 is continuously made, and then the filtration rate is measured until the filtration pressure becomes 1 MPa. The filtration quantity of the polymer solution 56 per unit size of the filter material can be calculated from the measured filtration rate, and described as t2 (m³). Further, the viscosity of the polymer solution before the storing process 19 is measured at 25° C. with capillary rheometer and described as V2(Pa·s).

In the present invention, the filtration quantity rate (t2/t1) is preferably at least 0.5, particularly at least 0.7, and especially at least 0.9. Note that the upper limit is at most 1. When the filtration quantity rate (t2/t1) is at least 0.5, the film obtained from the polymer solution 56 by the solution casting method described is excellent in the optical property. The reason for this effect is probably that the progress of the growth of the coarse particles can be reduced.

In the present invention, the viscosity rate (V1/V2) is preferably at least 0.8, particularly at least 0.9, and especially at least 0.95. Note that the upper limit is not restricted especially. However, it is at most 1.0. When the viscosity rate (V1/V2) is at least 0.8, the film obtained by the solution casting method described with use of the polymer solution 56 is excellent in the optical property. The reason for this effect is probably that the progress of the growth of the coarse particles can be reduced. Further, when the filtration quantity rate (t2/t1) and the viscosity rate (V1/V2) of the polymer solution 56 are controlled in the above range, the dope to be produced must be the most adequate to the film production.

If the above conditions are satisfied, the three dimensional valve 49b is driven to feed the polymer solution 56 through the filtration device 63 to the film production line 60. Further, the sampled polymer solution 56 after the filtration of the filtration device 58 is fed to the tank 59. If the above conditions are satisfied, the polymer solution 56 in the tank 59 may be fed through a pipe (not shown) to a filtration device 63. Thus the sample polymer solution 56 can be uses in the film production line 60. Furthermore, the same filtration device 58 is used in both of the first and second measurement processes 18, 20 in this embodiment. However, in the present invention, two filtration devices in which the absolute nominal diameter of the filter material is the same may be used for the first and second measurement processes 18, 20, respectively.

Note that the time interval between the first measurement process 18 and the second measurement process 20 is not restricted in two weeks. When the period for storing the polymer solution 56 in the storing process 19 is described as T, the time interval is preferably predetermined to a value in the range of 1×T to 50×T, particularly 2×T to 40×T, especially 5×T to 20×T.

The production method of the polymer solution 56 to be used in the present invention is not restricted in the above method. For example, after the cooling process 13 and the heating process 14, one of the first filtration process 15 and the second filtration process 17 may be made, and thereafter, the first measurement process 18, the storing process 19 and the second measurement process 20 may be performed sequentially. Otherwise, in order to perform the filtration process between the storing process 19 and the casting process 21, the filtration device 63 may be provided in downstream side from the stock tank 50. In this case, the filter material in the filtration device 63 may be the same as one of the filtration devices 47, 55.

Note that the method of producing the polymer solution is disclosed in detail in [0517] to [0616] in Japanese Patent Laid-Open Publication No. 2005-104148, for example, the dissolution method and the adding methods of the materials, the raw materials and the additive in the solution casting method for forming the TAC film, and the like. The description of the publication can be applied to the present invention.

[Solution Casting Method]

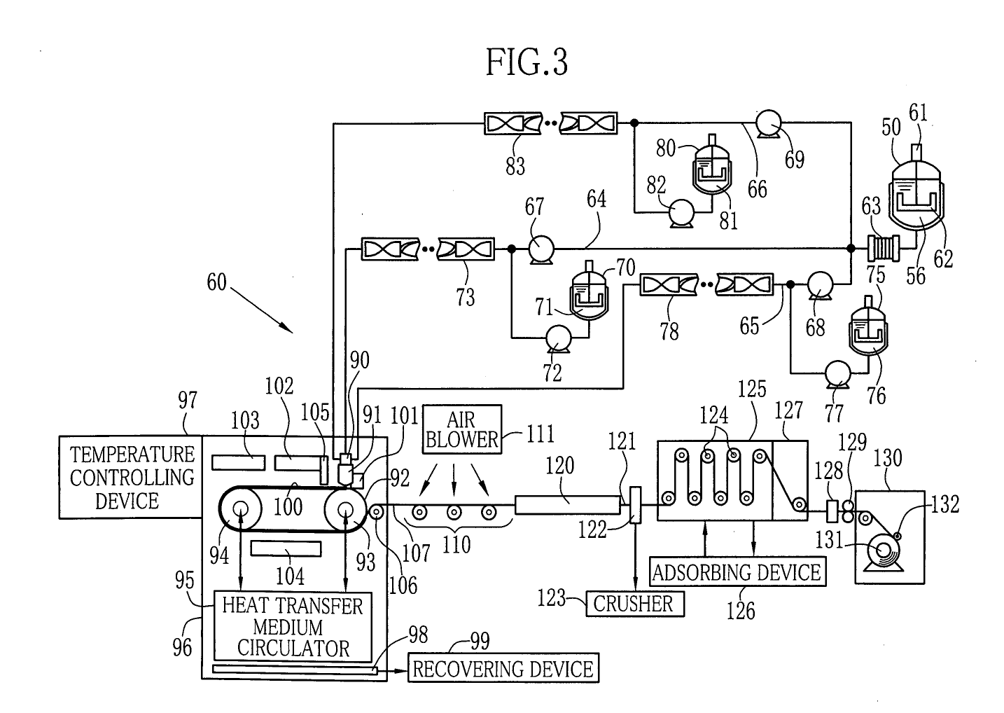

A solution casting method for forming a polymer film will be explained in followings in reference with FIG. 3. A stock tank 50 is connected through the filtration device 63 to a first path 64, a second path 65 and a third path 66. Further, at the casting, a casting film 100 is formed so as to have a lowermost layer, an uppermost layer and an intermittent layer sandwiched by the lower- and uppermost layers. Through the first-third paths 64-66, the polymer solution 56 is fed by pumps 67-69 respectively disposed on the first-third paths 64-66. Then, first to third dopes are respectively prepared from the polymer solutions 56 in the first-third paths, and fed to a feed block 90. After the feed block 90, these dopes are cast from a casting die 91 onto a belt 92. Note that when it is designated to form the three-layer structure film constructed of an intermittent layer, a lowermost layer (or base layer) and an uppermost layer, the lowermost layer is formed by casting the dope on the support directly. In this embodiment, the first-third dopes are used for forming the intermittent layer, the lowermost layer and the uppermost layer, respectively.

The stock tank 70 contains an additive 71, which are added to the polymer solution 56 fed in the first path 64 by a pump 72. Thereafter the mixture is stirred by a static mixer 73, so as to be uniform. Thus the first dope used for forming the intermittent layer is obtained. The additive 71 is a solution (or a dispersion) previously containing additive compounds, for example, UV absorbing agent, retardation controller and the like.

A stock tank 75 contains an additive 76, which are added to the polymer solution 56 fed in the second path 65 by a pump 77. Thereafter the mixture is stirred by a static mixer 78, so as to be uniform. Thus the second dope used for forming a lowermost layer of the polymer film on the belt 92 is obtained. The additive 76 previously contains additive compounds, for example, peeling agent (for example citric acid ester and the like) which makes the peeling of the polymer film from a belt as the support easy, matting agent (silicone dioxide and the like) for reducing the adhesion of film surfaces in the film roll, and the like. Note that the additive 76 may contain the additive compounds, such as plasticizer, UV absorbing agent and the like.

A stock tank 80 contains an additive 81, which are added to the polymer solution 56 fed in the third path 66 by a pump 82. Thereafter the mixture is stirred by a static mixer 83, so as to be uniform. Thus the third dope used for forming an uppermost layer of the polymer film on the belt 92 is obtained. The additive 81 contains the additive compounds, such as matting agent (silicone dioxide and the like) for reducing the adhesion of film surfaces in the film roll, and the like. Note that the additive 81 may contain the additive compounds, such as peeling accelerator, plasticizer, UV absorbing agent and the like.

The first-third dopes obtained by adding the additive to the polymer solution 56 are fed to the feed block 90 at a predetermined flow volume. The first-third dopes are joined and then cast from the casting die 91 to a belt 92.

The materials of the casting die 91 are preferably double phase stainless. The preferable material has coefficient of thermal expansion of at most 2×10⁻⁵ (° C.⁻¹). Further, the material to be used has an anti-corrosion property, which is almost the same as SUS316, in the examination of forcible corrosion in the electrolytic solution. Preferably, the materials to be used for the casting die 91 has such resistance of corrosion that the pitting doesn't occur on the gas-liquid interface even if the material is dipped in a mixture of dichloromethane, methanol and water for three months. The casting die 91 is preferably manufactured by performing the polishing after a month from the material casting. Thus the surface condition of the dope flowing in the casting die 91 is kept uniform. The finish precision of a contact face of both casting die and the feed block (explained later) 90 to the dopes is at most 1 μm in surface roughness and at most 1 μm/m in straightness. The clearance of a slit of the casting die 91 is automatically adjustable in the range of 0.5 mm to 3.5 mm. According to an edge of the contact portion of a lip end of the casting die 91 to the dope, R (R is chamfered radius) is at most 50 μm in all of a width. Further, the shearing rate in the casting die is controlled in the range of 1 to 5000 per second.

A width of the casting die 91 is not restricted especially. However, the width is preferably at least 0.8 times and at most 2.0 times as large as a film width. Further, it is preferable to attach a temperature controlling device (not shown) to the casting die 91, such that the temperature may be kept to the predetermined one during the film production. Furthermore, the casting die 91 is preferably a coat hanger type die.

In order to adjust a film thickness, the casting die 91 is preferably provided with an automatic thickness adjusting device. For example, thickness adjusting bolts (heat bolts) are disposed at a predetermined interval in a widthwise direction of the casting die 91. According to the heat bolts, it is preferable that the profile is set on the basis of a predetermined program, depending on feed velocity of pumps (preferably, high accuracy gear pumps) 67-69, while the film production is performed. Further, the feed back control of the adjustment value of the heat bolts may be made by the adjusting program on the base of the profile of a thickness meter (not shown), such as infrared ray thickness meter and the like. The thickness difference between any two points in the widthwise direction except the side edge portions in the casting film 100 is controlled preferably to at most 1 μm, and especially the largest difference of the minimal thickness in the widthwise direction is controlled at most 3 μm. Further, the accuracy to the designated object value of the thickness is preferably in +1.5 μm.

Preferably, a hardened layer is preferably formed on the lip end. A method of forming the hardened layer is not restricted. But it is, for example, ceramics hard coating, hard chrome plating, neutralization processing, and the like. If ceramics is used as the hardened layer, it is preferable that the used ceramics is grindable but not friable, with a lower porosity, high resistance of corrosion, and no adhesiveness to the casting die 91. Concretely, there are tungsten carbide (WC), Al₂O₃, TiN, Cr₂O₃, and the like. Especially preferable ceramics is tungsten carbide. Tungsten carbide coating can be made by an spraying method.

Further, in order to prevent the partial dry-solidifying of a dope flowing on a slit end of the casting die 91, it is preferable to provide a solvent supplying device (not shown) at the slit end, on which a gas-liquid interfaces are formed between both edges of the slit and between both bead edges and the outer gas. Preferably, these gas-liquid interfaces are supplied with the solvent which can dissolve the dope, (for example a mixture solvent of dichloromethane 86.5 pts.mass, acetone 13 pts.mass, n-butanol 0.5 pts.mass). Particularly preferably, in order to prevent the mixture of the foreign materials in the casting film 100, the solvent is supplied to each edge portions at the rate in the range of 0.01 mL/min to 10 mL/min. Thus the solidifications at both bead edges and the mixing of the solid into the casting film 100 are prevented. Note that the pump for supplying the solvent has a pulse rate at most 5%.

The belt 92 is positioned below the casting die 91, and lapped on back-up rollers 93, 94. When the back-up rollers 93, 94 are rotated by the driving device (not shown), and thus the belt 92 runs endlessly in accordance with the rotation of the back-up rollers 93, 94. Then the casting speed is preferably in the range of 10 m/min to 200 m/min. Further, the temperatures of the back-up rollers 93, 94 are controlled by a heat transfer medium circulator 95 for cycling a heat transfer medium. It is preferable that the surface temperature of the belt 92 is adjusted in the range of −20° C. to 40° C. by heat transmission from the back-up rollers 93, 94. In this embodiment, paths (not shown) of the heat transfer mediums are formed in the back-up rollers 93, 94, and the heat transfer mediums whose temperatures are controlled by the heat transfer medium circulator 95 pass through the paths. Thus the temperature of the back-up rollers 93, 94 are kept to the predetermined values.

The width and the length of the support 92 are not restricted especially. However, it is preferably 1.05 to 1.5 times as large as the casting width. Preferably, the length is from 10 m to 200 m, and the thickness is from 0.5 mm to 2.0 mm. The surface is preferably polished so as to have a surface roughness at most 0.05 mm. The belt 92 is preferably made of stainless steel, and especially of SUS 316 so as to have enough resistance of corrosion and strength. The thickness unevenness of the entire belt 92 is preferably at most 0.5%.

The drive of the back-up rollers 93, 94 is preferably controlled such that the tension generated in the belt 92 may be 1.5×10⁴ kg/m and (the difference of) the relative speed between the belt 92 and each back-up roller 93, 94 is at most 0.01 m/min. According to the control of the belt 92, preferably, the change of the running speed is at most 0.5% from the predetermined value, and the meandering in the widthwise direction in one cycle running is at most 1.5 mm. In order to reduce the meandering, a detector (not shown) is preferably provided above each edge portion of the belt 92, so as to make a feed-back control of the position of the belt on the basis of measured values. Furthermore, the position of the belt 92 shifts up- and downwardly in accordance with the rotation of the back-up roller 93. Therefore, it is preferable that the position of the belt 92 is preferably controlled just below the casting die 91, such that a shift range of the belt 92 may be at most 200 μm.

Note that it is possible to use one of the back-up rollers 93, 94 as support. In this case, the roller is preferably rotated at high accuracy, such that the rotation flutter may be a most 0.2 mm. Therefore the surface roughness is preferably at most 0.01 μm. Further, the chrome plating is preferably performed to the drum such that the drum may have enough hardness and endurance. As described above, it is preferable in the support(the belt 92 and the back-up rollers 93, 94) that the surface defect must be reduced to be minimal. Concretely there are no pin hole of at least 30 cm, at most one pin hole in the range of 10 μm to 30μm, and at most two pin holes of less than 10 μm per 1 m².

The casting die 91, the belt 92 and the like are included in a casting chamber 96, and a temperature controlling device 97 is provided for controlling the inner temperature of the casting chamber 96 to the predetermined value. Preferably, the inner temperature is in the range of −10° C. to 57° C. The organic solvent evaporated in the casting chamber 96 is condensed by a condenser 98. The condensed organic solvent is recovered by a recovering device 99 and used as the solvent for preparing the dope.

In the present invention, the first-third dopes produced as described above are co-cast to form the casting film 100 on the belt 92. Preferably, the temperatures of the first-third dopes are in the range of −10° C. to 57° C. Further, in order to stabilize the formation of a bead of the cast dopes, there is a decompression chamber 101 for controlling the pressure in the back side of the bead. The decompression is preferably made such that the pressure difference of a back to a front side from the bead may be in the range of 1 Pa to 800 Pa.

It is preferable to provide the decompression chamber 101 with a jacket (not shown) for controlling the inner temperature. The temperature of the decompression chamber 101 is not restricted especially. However, the temperature is preferably in the range of 20° C. to 70° C. Further, aspirators (not shown) may be provided with the decompression chamber 101 so as to be near both side edges of a dope outlet of the casting die 91. Thus the aspiration in both side edges of the bead is made to stabilize the shape of the bead. In this case, the force velocity of the aspiration is preferably in the range of one to one hundred Litter/min.

The casting film 100 is transported in accordance with the running of the belt 92. In this embodiment, it is preferable to provide air blowers 102, 103, 104 for feeding air blows to evaporate the solvent in the casting film 100. In this embodiment, the position for attachment of each air blower 102, 103, 104 is in an upper and upstream side, an upper and downstream side, and a lower side of the belt 92. However, the present invention is not restricted in it. Further, an air shielding device 105 is disposed close to the casting film 100 in the downstream side from the casting die 91. Although the drying airs cause to change surface conditions of the casting film 100 just after the formation, the air shielding device 105 reduces the change of the surface conditions. Further, in this figure, the belt is used as the support. However, a drum like the back-up roller may be used as the support, and the surface temperature of the drum is preferably in the range of −20° C. to 40° C.

When the casting film 100 has self-supporting property, it is peeled as a wet film 107 from the belt 92 with support of a peel roller 106. Thereafter, the wet film 107 is transported through a transport area 110 in which many rollers are provided, and then enters into a tenter device 120.

In the transport area 110, there is an air blower 111 for feeding a drying air whose temperature is a predetermined value. Thus the drying of the wet film 107 proceeds. At this moment, the temperature of the drying air from the air blower 111 is preferably in the range of 20° C. to 250° C. In the transport area 110, the rotation speed of the one roller is higher than the neighboring roller in the upstream side. Thus the tension can be applied to the wet film 107 in the transporting direction.

In the tenter device 120, both side edge portions of the wet film 107 are held by holding members, such as clips and the like, and the wet film 107 is dried with the transportation. The tenter device 120 of this embodiment stretches the wet film 107 in the widthwise direction. Thus, in the transport area 110 and/or the tenter device 120, it is preferable that the wet film 107 is stretched to become larger by 0.5% to 300% in at least one of the transporting direction (or a casting direction) and the widthwise direction.

The wet film 107 is dried until the content of the remaining solvent become the predetermined value, and fed out from the tenter device 120 as film 121 toward an edge slitting device 122 for slitting off both side edge portions. The slit side edge portions are sent to a crusher 123 by a cutter blower (not shown), and crushed to tips by the crusher 123. The tips are reused for preparing the dope, which is effective in view of the decrease of the production cost. Note that the slitting process of both side edge portions may be omitted. However, it is preferable to perform the slitting between the casting process and the winding process.

The film 121 whose side edge portions are slit off is sent to a drying chamber 125 and dried furthermore. In the drying chamber 125, the film 121 is transported with lapping on rollers 124. The inner temperature of the drying chamber 125 is not restricted especially. However, it is preferable in the range of 80° C. to 180° C. The solvent vapor evaporated from the film 121 by the drying chamber 125 is adsorbed by an adsorbing device 126. The air from which the solvent components are removed is reused for the drying air in the drying chamber 125. Note that the drying chamber 125 preferably has plural partitions for variation of the drying temperature. Further, a pre-drying device (not shown) is provided between the edge slitting device 122 and the drying chamber 125, so as to perform the pre-drying of the film 121. Thus it is prevented that the temperature of the film 121 increases rapidly, and therefore the change of the shape of the film 121 is reduced.

The film 121 is transported toward a cooling chamber 127, and cooled therein to around the room temperature. A humidity control chamber (not shown) may be provided for conditioning the humidity between the drying chamber 125 and the cooling chamber 127. Preferably, in the humidity control chamber, an air whose temperature and humidity are controlled is applied to the film 121. Thus the curling of the film 121 and the winding defect in the winding process can be reduced.

Thereafter, a compulsory neutralization device (or a neutralization bar) 128 eliminates the charged electrostatic potential of the film 121 to the predetermined value (for example, in the range of −3 kV to +3 kV). The position of the neutralization process is not restricted in this embodiment. For example, the position may be a predetermined position in the drying section or in the downstream side from a knurling roller 129, and otherwise, the neutralization may be made at plural positions. After the neutralization, the embossing of both side portions of the film 121 is made by the embossing rollers to provide the knurling. The emboss height from the bottom to the top of the embossment is in the range of 1 μm to 200 μm.

In the last process, the film 121 is wound by a winding shaft 131 in the winding chamber 130. At this moment, a tension is applied at the predetermined value to a press roller 132. Preferably, the tension is gradually changed from the start to the end of the winding. In the present invention, the length of the film 121 is preferably at least 100 m. The width of the film is preferably at least 600 mm, and particularly in the range of 1400 mm to 1800 mm. Further, even if the width is more than 1800 mm, the present invention is effective. The film thickness can be applied when it is designated to form a thin film of 15 μm to 100 μm in thickness.

In the solution casting method of the present invention, there are casting methods for casting plural dopes, for example, a co-casting method and a sequential casting method. In the co-casting method, the feed block 90 may be attached to the casting die 91 as in this embodiment, or a multi-manifold type casting die (not shown) may be used. In the film of multi-layer structure, at least one of the thickness of the peeled layer (lowermost layer) from the support and that of the opposite layer (uppermost layer) thereto is preferably in the range of 0.5% to 30% of the total film thickness. Furthermore, when it is designated to perform the co-casting, a dope of higher viscosity is sandwiched by lower-viscosity dopes. Concretely, it is preferable that the dopes for forming the surface layers (namely lower- and uppermost layers) have lower viscosity than the dope for forming a layer (intermittent layer) sandwiched by the surface layers. Further, when the co-casting is designated, it is preferable in the bead between die slit and the support that the composition of alcohol is higher in the two outer dopes than the inner dope.

As shown in FIG. 3, the three sorts of dopes are cast so as to easily form the film 121 as production object. Namely, the film 121 is wound to the film roll, it is necessary to prevent the adhesion of the film in the film roll. Therefore, it is preferable that the dope contains the matting agents. However, the matting usually agents cause the degradation in the optical properties (for example, the increase of haze). In this embodiment, accordingly, the matting agents are contained in the outer dopes for forming the lowermost and uppermost surface of the casing film on the support. Namely, the inner dope doesn't contain any matting agents. Thus the surface adhesiveness is decreased, and the film can have the designated optical properties.

Japanese Patent Laid-Open Publication No. 2005-104148 describes from [0617] to [0889] in detail about the structures of the casting die, the decompression chamber, the support and the like, and further about the co-casting, the peeling, the stretching, the drying conditions in each process, the handling method, the curling, the winding method after the correction of planarity, the solvent recovering method, the film recovering method. The descriptions thereof can be applied to the present invention.

[Properties & Measuring Method]

(Degree of Curl & Thickness)

Japanese Patent Laid-Open Publication No. 2005-104148 describes from [0112] to [0139] about the properties of the wound cellulose acylate film and the measuring method thereof. The properties and the measuring methods can be applied to the present invention.

[Surface Treatment]

The cellulose acylate film is preferably used in several ways after the surface treatment of at least one surface. The preferable surface treatments are vacuum glow discharge, plasma discharge under the atmospheric pressure, UV-light irradiation, corona discharge, flame treatment, acid treatment and alkali treatment. Further it is preferable to make one of these sorts of the surface treatments.

[Functional Layer]

(Antistatic, Curing, Antireflection, Easily Adhesive & Antiglare Layers)

The cellulose acylate film may be provided with an undercoating layer on at least one of the surfaces, and used in the several ways.

It is preferable to use the cellulose acylate film as a base film to which at least one of functional layers may be provided. The preferable functional layers are an antistatic layer, a cured resin layer, an antireflection layer, an easily adhesive layer, an antiglare layer and an optical compensation layer.

These functional layers preferably contain at least one sort of surfactants in the range of 0.1 mg/m² to 1000 mg/m². Further, the functional layers preferably contain at least one sort of plasticizers in the range of 0.1 mg/M² to 1000 mg/M². The functional layers preferably contain at least one sort of matting agents in the range of 0.1 mg/m² to 1000 mg/m². The functional layers preferably contain at least one sort of antistatic agents in the range of 1 mg/M² to 1000 mg/M².

Conditions and Methods for forming the functional layer are described in detail from [0890] to [1087] of Japanese Patent Laid-Open Publication No. 2005-104148, which can be applied to the present invention. Thus, the produced film can have several functions and properties.

(Variety of Use)

The produced cellulose acylate film can be effectively used as a protection film for a polarizing filter. In the polarizing filter, the cellulose acylate film is adhered to a polarizer. Usually, two polarizing filters are adhered to a liquid crystal layer such that the liquid crystal display may be produced. Note that the arrangement of the liquid crystal layer and the polarizing filters are not restricted in it, and several arrangements already known are possible. Japanese Patent Laid-Open Publication No.2005-104148 discloses the liquid crystal displays of TN type, STN type, VA type, OCB type, reflective type, and other types in detail. The description may be applied to the present invention.

Further, in the description of this application, a cellulose acylate film is provided with an optically anisotropic layer, and another cellulose acylate film is provided with antireflective and antiglare functions. Further, the publication describes about the optically biaxial cellulose acylate film provided with adequate optical properties. This cellulose acylate film may be used with the protective film for the polarizing filter. These descriptions of the Laid-Open Publication No.2005-104148 continues from [1088] to [1265], which can be applied to the present invention.

[Experiment]

According to the present invention, an experiment was made. In followings, examples and comparisons of the experiment will be described.

(Composition)

| | |
|---|---|
| Cellulose Triacetate | 14.5 pts. mass |
| (Powder: degree of substitution, 2.80; viscosity- | |
| average degree of polymerization, 306; water content, | |
| 0.2 mass %; viscosity of 6 mass % dichloromethane | |
| solution, 315 mPa · s; averaged particle | |
| diameter, 1.5 mm; standard deviation of | |
| averaged particle diameter, 0.5 mm) | |
| Methyl acetate | 67.69 pts. mass |
| Acetone | 6.69 pts. mass |
| Ethanol | 5.85 pts. mass |
| n-butanol | 3.34 pts. mass |
| Plasticizer A | 0.29 pts. mass |
| (trimethylolpropane triacetate) | |
| Plasticizer B | 0.91 pts. mass |
| (trimphenyl phosphate) | |
| Plasticizer C | 0.54 pts. mass |
| (biphenyldiphenyl phosphate) | |
| Plasticizer D | 0.091 pts. mass |
| (ethylphthalylglycol ethylester) | |
| UV-agent A | 0.05 pts. mass |
| (2,4-bis-(n-octylthio)-6-(4-hydroxy-3,5-di-tert- | |
| butylanylino)-1,3,5-triazine) | |
| UV-agent B | 0.05 pts. mass |
| (2(2′-hydroxy-3′,5′-di-tert-butylphenyl)-5- | |
| chlorobenzotriazol) | |
| UV-agent C | 0.1 pts. mass |
| (2(2′-hydroxy-3′,5′-di-tert-amylphenyl)-5- | |
| benzotriazol) | |

According to cellulose triacetate used in this experiment, the remaining content of acetic acid was at most 0.1 mass %, the Ca content was 58 ppm, the Mg content was 42 ppm, the Fe content was 0.5 ppm, the free acetic acid content was 40 ppm, and the sulfuric ion content was 15 ppm. The degree of acetylation at 6^{th} position was 0.91, and the percentage of acetyl groups at 6^{th} position to the total acetyl groups was 32.5%. The acetone extract was 8 mass %, and a ratio of weight-average molecular weight to number-average molecular weight was 2.5. Further, yellow index was 1.7, haze was 0.08, and transparency was 93.5%. Tg (measured by DSC) was 160° C., and calorific value in crystallization was 6.4 J/g. This cellulose triacetate A (hereinafter TAC-A) is synthesized from cellulose as material obtained from cotton.

About methyl acetate as the main solvent, solubility parameter was 19.6, dielectric constant was 6.68, oxygen fractional ratio (or oxygen mole fraction) was 0.43, dipole moment was 1.61 D, molecular weight was 74, boiling point was 57° C., I/O value was 2.13, and the preferable solvent compound to the present invention. Further, about acetone which is simultaneously used with methyl acetate, solubility parameter was 20.3, dielectric constant was 20.7, oxygen fractional ratio (or oxygen mole fraction) was 0.28, dipole moment was 2.69D, molecular weight was 58, boiling point was 56° C., I/O value was 1.08, and the preferable solvent compound to the present invention.

The polymer solution was prepared with use of the dope production line 30 in FIG. 2. The dissolution tank 33 with the first and second stirrers 39, 41 was made of stainless and the volume thereof was 4000 L. Into the dissolution tank 33, a plurality of solvent compounds were mixed such that a mixture solvent was obtained. While the stirring of the mixture solvent was made, the cellulose triacetate flakes were added from the hopper 34 to the mixture solvent gradually, such that the total mass of the mixture solution and the cellulose triacetate flakes might be 2000 kg. Note that the water content in each solvent compounds (methyl acetate, n-butanol, acetone and ethanol) is at most 0.5 mass %. The powder of cellulose triacetate was supplied into the dissolution tank. The stirring was made with use of the first stirrer 39 having the anchor blade and the second stirrer 41 which was eccentric stirrer of dissolver type. At first, the first stirrer 39 performed the stirring at one m/sec as circumferential velocity (shear stress was 1×10⁴ kgf/m/sec²), and the second stirrer 41 performed the stirring at shear rate at first 15 m/sec (shear stress was 5×10⁴ kgf/m/sec²). Thus the dispersion was made for 30 minutes during the stirring. The dissolving started at 25° C., and the temperature of the dispersion became 48° C. at last. After the dispersion, the high speed stirring (of the second stirrer 21) was stopped, and the stirring was performed by the first stirrer 19 at 0.5 m/sec as circumferential velocity for 100 minutes. Thus cellulose triacetate flakes was swollen such that the swelling liquid 42 was obtained. Until the end of the swelling, the inner pressure of the dissolution tank 33 was increased to 0.12 MPa with use of nitrogen gas. At this moment, the hydrogen concentration in the dissolution tank was less than 2 vol. %, which does not cause the explosion. Further, water content in the polymer solution was 0.3 mass %.

The swelling liquid 42 was fed from the dissolution tank 33 to the cooling device 44 by the pump 43. As the cooling device, the screw extruder was used, and a upstream side pressure was 0.55 MPa. The screw was provided with a jacket for making the cooling medium flow. The cooling medium was Florinate FC-77 (registered trademark) produced by 3M Company. The feeding was made continuously at −80° C. The cooling medium was cooled by the direct expansion refrigerating machine. The averaged flow speed in the jacket was 2 m/sec, and the averaged retention time of the solution in the screw was 35 seconds. Then the additive liquid was added at 3 wt. % to the swelling liquid 42. In order to prepare the additive liquid, a mixture solvent is prepared in mass ratio, (methyl acetate):(acetone):(ethanol): (1-butanol)=81:8:7:4. Then, n-butanol was added to the mixture solvent in weight ratio, 50:50. After the addition of the additive liquid to the swelling liquid 42, the retention of the swelling liquid 42 in the static mixer 45 was performed for 30 minutes. These treatments were made such that pH of the swelling liquid 42 might be 5. After the addition of the additive liquid and the retention, the generation of the micro gel-like materials was not observed in the swelling liquid 42. Thereafter, the swelling liquid 42 was heated to 50° C. by the heating device 46. In this experiment, the heating device 46 was a pipe with jacket, and there was static mixer in the pipe. The swelling liquid was fed out as the polymer solution from the heating device 46, and the filtration of the polymer solution was made by the filtration device 47 in which a filter was made of sintered metal fiber and nominal diameter thereof was 10 μm. In the filtration, the upstream side filtration pressure was 1.5 MPa, and the downstream side filtration pressure was 1.2 MPa.

The polymer solution was fed into the flushing device 51 whose pressure was kept to the atmospheric pressure at 120° C., such that the flush evaporation of the polymer solution was made. The solvent vapor was condensed by the condenser to the liquid state, and recovered by the recovering device 52. After the flushing, the content of solid compounds in the polymer solution was 21.8 mass %. Note that the recovered solvent was recycled by the recycling device 53 and reused. The anchor blade is provided at a center shaft of a flush tank of the flushing device 51, and the polymer solution was stirred by the anchor blade at 0.5 m/sec as circumferential velocity. The temperature of the polymer solution in the flush tank was 25° C., the retaining period of the polymer solution in the flush tank was 50 minutes. Part of the polymer solution was sampled, and the measurement of the shearing viscosity was made at 25° C. The shearing viscosity was 450 Pa·s at 10 (1/s) of shearing rate.

Then the defoaming was further made by irradiating very weak ultrasonic waves. Thereafter, the polymer solution was fed to the filtration device 55 by the pump 54. In the filtration device 55, the polymer solution was fed at first through a sintered metal filter whose nominal diameter was 10 μm, and then through the same filter of 10 μm nominal diameter. At the forward and latter filters, the upstream side pressures were respectively 0.4 MPa and 0.4 MPa, and the downstream side pressures were respectively 0.1 MPa and 0.1 MPa. The temperature of the polymer solution after the filtration was controlled to 25° C., and the polymer solution stored as the polymer solution 56 in the stainless stock tank 50 whose volume was 2000 L. The anchor blade is provided to a center shaft of the stock tank 50, and the polymer solution 56 was always stirred by the anchor blade at 0.3 m/sec as circumferential velocity. Note that when the concentrating of the polymer solution is made, corrosions of parts or portions contacting to the polymer solution in the devices and devices didn't occur at all.

The film was formed in a film production line 60 shown in FIG. 3. The pumps 67, 68, 69 for increasing the upstream side pressures were high accuracy gear pumps and driven to feed the polymer solution 56 through the filtration device 63 (filter material: sintered stainless fiber (averaged nominal diameter was 10 μm)), while the feed back control was made by an inverter motor. Thus the upstream side pressure of high accuracy gear pump was controlled to 0.8 MPa. As for the pumps 67-69, volumetric efficiency was 99.2%, and the variation rate of the discharging was at most 0.5%. Further, the discharging pressure was 1.5 MPa.

The casting die 91 has the feed block 90 which is 1.8 m in width and adequate for the co-casting, such that not only the main dope (corresponding to the first dope) but also the two dopes (corresponding to the second and third dopes) on both surfaces of the main dope can be cast simultaneously. Thus the produced film has three-layer structure. The polymer solution 56 was fed through the first-third paths 64-66.

The additive 71 for the intermittent layer was prepared from trimethylol triacetate (15 pts.mass) and the mixture solvent (85 pts.mass), and contained in the stock tank 70. Then the additive 71 was fed from the stock tank 70 to the first path 64 by the pump 72, and thus added to the polymer solution 56. Thereafter, the mixing was made by the static mixer 73 in which the element number was 48, such that the dope for forming the intermittent layer was obtained. The content control was made such that the total solid content might be 21.8 mass % and the retardation controller content in the film might be 4.0 mass %.

Silicone dioxide (particle diameter, 20 nm; Mohs Hardness, about 7) as matting agent, and citric acid ethylester ((citric acid):(ethylalchohol)=1:1 in molar ratio) as peeling agent were dissolved to or dispersed in the and the mixture solvent. Thus the additive 76 for the lowermost layer was obtained in liquid state. The additive 76 was stored in the stock tank 75, and fed out by the pump 77 at the predetermined flow volume to the polymer solution 56 which is flowing in the second path 65. Then the additive 76 and the polymer solution 56 was mixed by the static mixer 78 (element number was 48) such that the dope for forming the lowermost layer was obtained. The content control was made such that the total solid content might be 20.5 mass %, the matting agent content might be 0.05 mass %, and the peeling agent content might be 0.03 mass %.

Silicone dioxide (particle diameter, 15 nm; Mohs Hardness, about 7) as matting agent was dispersed in the mixture solvent, such that the additive 81 for the uppermost layer was obtained in the liquid state. The additive was stored in the stock tank 80, and fed out by the pump 82 to the polymer solution 56 which is flowing in the third path 66. Then the mixture of the additive 56 and the polymer solution 56 is mixed by the static mixer 83 (element number was 48) such that the dope for forming the lowermost layer was obtained. The content control was made such that the total solid content might be 20.5 mass %, and the matting agent content might be 0.1 mass %.

The casting speed (line speed) was 50 m/min such that the thickness of each of the uppermost layer, the intermittent layer and lowermost layer in the TAC film might be respectively 4μm, 73 μm, and 3 μm, and the film thickness might be 80 μm the casting width was 1700 mm, and the flow rate of each cellulose triacetate dope at die lips was adjusted during the casting. The casting die 91 was provided with a jacket in which heat transfer medium was supplied. The temperature of the heat transfer medium at an entrance of the jacket was 25° C., such that the temperature of the dope might be 25° C.

The casting die 91 was the coat hunger type, in which heat bolts for adjusting the film thickness were disposed at the pitch of 20 mm. Thus the film thickness (or the thickness of the dopes) are automatically controlled by the heat bolt. A profile of the heat volt can be set corresponding to the flow rate of the high accuracy gear pump, on the basis of the preset program. Thus the feed back control can be made by the control program on the basis of the profile of an infrared ray thickness meter (not shown) disposed in the film production line 60. The control was made such that, with exception of both side edge portions (20 mm each in the widthwise direction of the produced film), the difference of the film thickness between two positions which were 50 mm far from each other might be at most 1 μm, and the largest difference between the minimal values of the film thickness in the widthwise direction might be at most 3 μm/m. Further, the control was made such that the averaged thickness accuracy of each of the uppermost and lowermost layers might be ±2%, that of the intermittent layer might be at most 1%, and the average film thickness might be at most ±1.5%.

In the upstream side of the casting die 91, there is a decompression chamber 101. The decompression rate of the decompression chamber was controlled in accordance with the casting speed, such that the pressure difference might occur in the range of one Pa to 5000 Pa between the upstream and downstream sides from the bead of the cast dope above the casting die. At this time, the pressure difference was controlled such that the bead length might be 6 mm±0.5 mm. Further, an instrument was provided such that the temperature of the decompression chamber 101 might be set to be higher than the condensation temperature of the gas around the casting section. Further, there were labyrinth packings (not shown) in the upstream and downstream sides of the beads. Further, an opening was provided in both edges. Further, an edge suctioning device (not shown) for reducing the disturbance of the bead was provided.

The material of the casting die was the double layer stainless alloy, whose coefficient of thermal expansion was at most 2×10⁻⁵ (° C.⁻¹) In the compulsory corrosion experiment in an electrolyte solution, the corrosion resistance was almost the same as that of SUS316. Further, the material to be used for the casting die had enough corrosion resistance, such that the pitting (or pitting corrosion) might not occur on the gas-liquid interface even if this material were dipped in a mixture liquid of dichloromethane, methanol and water for three months. The finish accuracy of the contact surface of each casting die 91 and feed block 90 was at most 1 μm in surface roughness, the straightness was at most 1 μm in any directions, and the slit clearance was adjusted to 1.5 mm in straightness. According to an edge of the contact portion of a lip end of the casting die 91, R is at most 50 μm in all of a width. Further, the shearing rate in the casting die is controlled in the range of one to 5000 per second. Further, the WC coating was made on the lip end from the casting die 91 by a melt extrusion method, so as to provide the hardened layer.

In order to prevent the dry and solidification on part of the slit end of the casting die 91, the mixture solvent dissolvable of the solidified dope was supplied to each edge portion of the gas-liquid interface of the slit at 0.5 ml/min. Thus the mixture solvent is supplied to each bead edge. The pulse rate of a pump for supplying the mixture solvent was at most 5%. Further, the decompression chamber 101 was provided for decreasing the pressure in the rear side by 150 Pa. In order to control the temperature of the decompression chamber 101, a jacket (not shown) was provided, and a heat transfer medium whose temperature was controlled at 55° C. was supplied into the jacket. The edge suction rate could be controlled in the range of 1 L/min to 100 L/min, and was adequately controlled in this experiment so as to be in the range of 30 L/min to 40 L/min.

The belt 92 was an endless stainless belt which was 2.1 m in width and 70 m in length. The thickness of the belt 92 was 1.5 mm, and the surface of the belt 92 was polished, such that the surface roughness might be at most 0.05 μm. The material was SUS316, which had enough corrosion resistance and strength. The thickness unevenness of the entire belt 92 was at most 0.5% of the predetermined value. The belt 92 was moved by rotating the back-up rollers 93, 94. At this moment, the tension of the belt 92 was controlled to 1.5×10⁴ kg/m. Further, the relative speed to each roller to the belt 92 changed. However, in this experiment, the control was made such that the difference of the relative speed between the back-up rollers 93, 94 was at most 0.01 m/min. Further the control was made such that the variation of the speed of the belt 92 was at most 0.5% to the predetermined value. The position of the belt in the widthwise direction was controlled with detection of the position of the side end, such that meandering in one circle of the moving belt 92 was reduced in 1.5 mm. Further, below the casting die 91, the variation of the position in the vertical direction between the lip end of the casting die and the belt 92 was in 200 μm. The belt 92 is preferably incorporated in the casting chamber 96 which has air pressure controller (not shown). The three dopes (for forming the uppermost, intermittent and lower most layers) were cast onto the belt 92 from the casting die 91.

In this experiment, the back-up rollers 93, 94 were supplied therein with a heat transfer medium, such that the temperature of the belt 92 might be controlled. The back-up roller 93 disposed in a side of the casting die 91 was supplied with the heat transfer medium (Naibrine aqueous solution) at 15° C., and the back-up roller 94 was supplied with the heat transfer medium (Naibrine aqueous solution) at 40° C. The surface temperature of the middle portion of the belt 92 at a position just before the casting was 15° C., and the temperature difference between both sides of the belt was at most 6° C. Note that a number of pinhole (diameter, at most 30 μm) was zero, a number of pinhole (diameter, 10 μm to 30 μm) was at most one in square meter, and a number of pinhole (diameter, less than 10 μm) was at most two in square meter.

The temperature of the casting chamber 96 controlled to 35° C. by the temperature controlling device 97. The dopes were cast onto the belt 92 to form the casting film 100, and the drying air was fed out as parallel air wind from the air blowers 102, 103, 104. The overall heat transfer coefficient from the drying air to the belt 92 was 24 kcal/(m²·hr·° C.). Above the belt 92, the temperature of the drying air was 135° C. in the upstream side and 140° C. in the downstream side. Further, below the belt 92, the temperature of the drying air was 65° C. The saturation temperature of each air was around −8° C. The oxygen concentration in the drying atmosphere on the belt 92 was kept at 5 vol. %. In order to keep the oxygen concentration at 5 vol. %, the air was substituted by the nitrogen gas. Further, in order to condense and recover the solvent in the casting chamber 96, the condenser 98 was provided, and the temperature of the exit was set to −10° C.

The static pressure fluctuation was controlled in ±1 Pa, such that the drying air was not be direct1 y applied to the dope and the casting film 100 for five second after the casting. When the solvent ratio in the casting film became 150 mass % of dry weight standard, the casting film 100 was peeled as the wet film 107 from the belt 92 with support of the peel roller. At the peeling, the peeling tension was 10 kgf/m. Further, in order to reduce the peeling defect, the peeling speed was adequately controlled such that the percentage thereof to the speed of the belt 92 might be in the range of 100.1% to 105%. The surface temperature of the wet film 107 was 15° C. . According to the drying speed, 180 mass % of the solvent in dry weight standard was evaporated per minute in average. The solvent vapor generated in the drying was condensed at −10° C. by the condenser 98, and recovered by the recovering device 99. The recovered solvent was reused after the conditioning thereof. At this moment, the water content in the solvent was at most 0.5%. The air from which the solvent was removed was heated again and reused as the drying air. The wet film 107 was transported toward the tenter device 120 by the rollers in the transport area 110. At this moment, the air blower fed the drying air at 40° C. to the wet film 107. While the wet film 107 was transported in the transport area 110, the tension about 30N was applied to the wet film 107.

In the tenter device 120, both side edge portions of the wet film 107 was held by clips, and then transported in a drying zone for performing the drying. The clip was supplied with a heat transfer medium at 20° C. The drive of the tenter device was made with use of chain, and the speed variation of sprockets of the chain was at most 0.5%. Further, the inside of the tenter device 120 was partitioned into three zones, in which the temperatures of the drying airs were 90° C., 100° C. and 110° C. sequentially from the upstream side. The drying air had composition so as to be saturated at −10° C. According to the drying speed in the tenter device 120, the 120 mass % of the solvent of dry weight standard was evaporated per minute in average. The conditions of the drying zones were adjusted such that the remaining content of the solvent in the film might be 7 mass % at an exit of the tenter device 120. Further, in the tenter device 120, the stretching in the widthwise direction was made as the transportation was made. If the percentage of the film width of the wet film 107 before the tenter device 120 was determined to 100%, the stretching ratio of the film width after the tenter device 120 was 103%. Further, the film was drawn in the lengthwise direction between the peel roller 106 and the tenter device 120. The drawing ratio in percentage was 102%. According to the stretching ration in the tenter device 120, the difference of the actual stretching ratio was at most 10% between parts which were at least 10 mm apart from the holding positions of the clips, and at most 5% between parts which were 20 mm apart from the holding portions. In the side edge portions in the tenter device 120, the ratio of the length in which the fixation was made was 90%. The solvent vapor generated in the tenter device 120 was condensed at −10° C. to a liquid state and recovered. For the condensation, a condenser (not shown) was provided, and a temperature at an exit thereof was −8° C. The water content in the recovered solvent was regulated to at most 0.5 mass %, and then the recovered solvent was reused. The wet film 107 was fed out as the film 121 from the tenter device 120.

In 30 seconds from exit of the tenter device 120, both side edge portions were slit off in the edge slitting device 122. In this experiment, each side portion of 50 mm in the widthwise direction of the film 121 was determined as the side edge portion, which were slit off by an NT type slitter of the edge slitting device 122. The slit side edge portions were sent to the crusher 123 by applying air blow from a blower (not shown), and crushed to tips about 80 mm2. The tips were stored into edge silos for reusing as raw material with the TAC flakes for the dope production. In the edge silo, there was a concentration meter for measuring and monitoring the concentration of the solvent. The solvent in the edge silo has lower explosion limit (hereinafter, % LEL value (LEL: Lower Explosion Limit)) at 25%. If the % LEL becomes more than 25 vol. %, an explosion can be occur. However, in this Experiment, since the % LEL was always kept to at most 25 vol. %, the explosion was prevented. The oxygen concentration in the drying atmosphere in the tenter device 120 was kept to 5 vol. %. Note that the air was substituted by nitrogen gas in order to keep the oxygen concentration at 5 vol. %. Before the drying at the high temperature in the drying chamber 125, the pre-heating of the film 121 was made in a pre-heating chamber (not shown) in which the air blow at 100° C. was supplied.

The film 121 was dried at high temperature in the drying chamber 125, which was partitioned into four partitions. Air blows whose temperatures were 120° C., 130° C., 130° C. and 130° C. from the upstream side were fed from air blowers (not shown) to the partitions. The transporting tension of each roller 124 to the film 121 was 100 N/width. The drying was made for ten minutes such that the content of the remaining solvent might be 0.3 mass %. The lapping angle of the roller 4 was 90° and 180°. The rollers 124 were made of aluminum or carbon steel. On the surface, the hard chrome coating was made. The surfaces of the rollers 124 were flat or processed by blast of matting process. The swing of the roller in the rotation was in 50 μm. Further, the bending of each roller 124 at the tension of 100 N/width was reduced to at most 0.5 mm.

The solvent vapor contained in the drying air is removed with use of the adsorbing device 106 in which an adsorbing agent was used. The adsorbing agent was active carbon, and the desorption was performed with use of dried nitrogen. The recovered solvent was reuse as the solvent for the dope preparation after the water content might be at most 0.3 mass %. The drying air contains not only the solvent vapor but also gasses of the plasticizer, UV-absorbing agent, and materials of high boiling points. Therefore, a cooler for removing by cooling and a preadsorber were used to remove them. Thus the drying air was reused. The ad- and desorption condition was set such that a content of VOC (volatile organic compound) in exhaust gas might be at most 10 ppm. Furthermore, in the entire solvent vapor, the solvent content to be recovered by condensation method was 90 mass %, and almost of the remaining solvent vapor was recovered by the adsorption recovering. The compulsory neutralization device (or a neutralization bar) 128 was provided, such that the charged electrostatic potential of the film might be in the range of −3 kV to +3 kV during the transportation.

The dried film 121 was transported into a first humidity control chamber (not shown). Between the drying chamber 125 and the first humidity control chamber, there was an transport area into which a drying air at 110° C. was fed. In the first humidity control chamber, an air whose temperature and dewing point were respectively 50° C. and 20° C. was fed. Further, the film 121 was transported into a second humidity control chamber (not shown) for preventing the curling of the film 121. In the second humidity control chamber, an air whose temperature and humidity were respectively 90° C. and 70% was directly applied.

After the humidity control, the film 121 was cooled in the cooling chamber 127 such that the temperature of the film might be at most 30° C. Then the edge slitting of both film edge portions were made. Further, the compulsory neutralization device (or a neutralization bar) 128 eliminated the charged electrostatic potential of the film 121 in the range of −3 kV to +3 kV. After the neutralization, the embossing of both side portions of the film 121 was made by the knurling rollers 129 to provide the knurling. The knurling width was 10 mm, and the knurling pressure was determined such that the maximal emboss height might be 12 μm in average larger than the averaged thickness.

The film 121 was transported to a winding chamber 130, whose inside temperature and humidity were respectively kept to 28° C. and 70%. Further, a compulsory neutralization device (not shown) was provided, such that the charged electrostatic potential of the film might be in the range of −1.5 kV to +1.5 kV. The obtained film 121 was 1475 mm in width and 80 μm in thickness. The diameter of the winding shaft 131 was 169 mm. The tension pattern was set such that the winding tension was 360 N/width at first, and 250 N/width at last. The film 121 was entirely 3940 m in length. The film meandering cycle was 400 m, and the oscillation width was in +5 mm. Further, the pressure of the press roller 112 to the winding shaft 131 was set to 50 N/width. The temperature of the film at the winding was 25° C., the water content was 1.4 mass %, and the content of the remaining solvent was 0.3 mass %. Through all processes, according to the drying speed, 20 mass % of the solvent in dry weight standard was evaporated per minute in average. Further, the loose winding and wrinkles didn't occur, and the film didn't transit in the film roll even in 10 G impact test. Further, the roll appearance was good.

The film roll of the film 121 is stored in the storing rack under the conditions of 55% RH and 25° C. for one month. Then the inspection was made in the same way as above, but the remarkable change of the film conditions was not recognized. Further, the adhesion of the film didn't occur in the film roll. After production of the film 121, any part of the casting film 100 formed of the dope was not recognized on the belt 92.

[Estimations & Results]

The estimation method of the sample obtained in the examination will be described.

(1) Stability of Polymer Solution

The polymer solution after the filtration and the condensation was sampled, and stationary stored at 30° C. In this situation, the observation of the sample was made. The estimation was made in the following grades.

A: The sample of the polymer solution kept the transparency and uniformity even after 20 days.

B: The sample kept the transparency and uniformity even after 10 days. However, the sample became clouded in white after 20 days.

C: The sample was a transparent and uniform liquid until the completion of the dope production. However, the gelatization occurs and thus the sample became nonuniform after one day.

D: In the sample, the swelling and the dissolution were not observed. The sample was opaque and nonuniform.

(2) Surface Condition of Film

The observation of the film was made with eyes, and the surface condition thereof was estimated.

A: The film surface was smooth.

B: The film surface was smooth. However, there were some foreign materials.

C: The film surface was slightly not smooth, and the foreign materials were observed clearly.

D: The film surface was not smooth, and there were many foreign materials.

(3) Heat Resistance of Film

One gram of the sample was folded and put into a glass bottle whose volume was 15 ml. Then the moisture control was made under the condition of the temperature at 90° C. and the relative humidity at 100%. After the moisture control the bottle was tightly closed. The temperature was kept at 90° C. for 10 days, and then the sample was extracted from the bottle. The film condition was observed with eyes, and the following estimations were made.

A: There were no aberrations especially.

B: The decomposition smell was observed slightly.

C: The decomposition smell was observed so much.

D: The decomposition smell was observed, and the decomposition changes the shape of the sample film.

(4) Moisture Permeation Constant of Film

The moisture permeation of the film was measured after the disposition of the film for one day under the condition at 60° C. and 95% RH. Then the following estimation was made. (In the estimation grade, MP means moisture permeation).

MP-A: less than 1250 (g/m²·day)

MP-B: at least 1250 (g/m²·day ) and less than 2000(g/m²·day)

MP-C: at least 2000 (g/m²·day ) and less than 2750(g/m²·day )

MP-D: at least 2750 (g/m²·day)

According to the obtained film 121, the stability of the polymer solution was A, and the surface condition of the film was A. In the film tearing examination, the sample was tore at 16 g. In the folding resistance examination of the film, the sample was not broken until 71 times folding. The heat resistance of the film was A. Therefore, the film 121 was excellent in these estimations. Further, the content of the remaining acetic acid was less than 0.01 mass %, and the film sample contains Ca (less than 0. 05 mass %) and Mg (less than 0.01 mass %). The thickness of the film 121 was entirely in the range of 80 μm±1.5 μm.

By the way, the forward and backward ends and the middle area of the film 121 were sampled. In each sample, the estimations of both side edge portions and central portion in the widthwise direction were made. In the data of these estimations, the error was in 0.2%. Further, averaged film heat shrinkage in length- and crosswise directions was −0.085% (conditions; 90° C. and 24 hours). Therefore the heat shrink hardly occurs in the obtained film 121. Further, the content of the remaining solvent was 7 mass % at the exit of the tenter device, and at this time, the % LEL value in an edge silo LEL was less than 25%.

Further, the film 121 had Haze at 0.3%, Transparency at 92.4%, inclination width at 19.6 nm, limit wavelength at 392.7 nm, absorption end at 374.1 nm, 2.0%-absorption of 380 nm optical light, Re at 1.2 nm, and Rth at 48 nm. The molecular orientation axis was 1.4°. The elastic modulus was 3.54 GPa in the lengthwise direction and 3.45 GPa in the widthwise direction. The tension strength was 142 MPa in the lengthwise direction and 141 MPa in the widthwise direction. The tension rate was 43% in the lengthwise direction and 49% in the widthwise direction. The coefficient of static friction was 0.65 and that of dynamic friction was 0.51. The alkali hydrolyzability was A, degree of curl was −0.4 under 25% RH and 1.7 in the wet condition. Further, the water content was 1.4 mass %, the content of the remaining solvent was 0.3 mass %. The moisture permeation constant was 540 g/(m²·day), and the heat shrinkage was −0.09% in the lengthwise direction and −0.08% in the widthwise direction. About the foreign materials, the lint was observed less than 5 points per one meter. The luminescent spots were observed. In three meter of the film, there were less than 10 luminescent spots from 0.02 mm to 0.05 mm, and less than 5 luminescent spots from 0.05 mm to 0.1 mm. There were no luminescent spots at least 0.1 mm. Therefore, the obtained film has excellent characteristics for the optical use. Further, after the coating, the adhesion didn't occur and the moisture permeation was good.

The estimation method of the polymer solution of the present invention can be applied to methods for estimating the physical properties of the condensed solution depending time.

Various changes and modifications are possible in the present invention and may be understood to be within the present invention.

What is claimed is:

1. An estimation method of a dope for a solution casting, said dope containing polymer and solvent, comprising steps of:
performing a first filtration of said dope with a first filter having an averaged nominal diameter in the range of 5 μm to 50 μm, a flow rate of said dope being decided such that initial filtration pressure may be 0.1 MPa;
measuring a filtration quantity t1 (m³) of said dope through a unit size of said first filter until filtration pressure becomes 1 MPa;
storing said dope in a vessel for two weeks after said first filtration;
performing after the storage a second filtration of said dope with a second filter having the same averaged nominal diameter as said first filter, a flow rate of said dope being decided such that initial filtration pressure may be 0.1 MPa;
measuring a filtration quantity t2 (m³) of said dope through a unit size of said second filter until filtration pressure becomes 1 MPa; and
using for said solution casting method said dope satisfying that a value t2/t1 is at least 0.5.

2. An estimation method according to claim 1, further comprising a step of performing before said first filtration a third filtration by feeding said dope through a third filter.

3. An estimation method according to claim 1, wherein when a viscosity of said dope is described as V1 (Pa·s) for said first filtration and V2 (Pa·s) for said second filtration, a viscosity ratio V1/V2 is at least 0.8.

4. An estimation method according to claim 1, wherein said polymer is cellulose acylate.

5. An estimation method according to claim 1, wherein said solvent contains methyl acetate.

6. An estimation method of a dope for a solution casting method, said dope containing polymer and solvent, comprising steps of:
performing a first filtration of said dope with a first filter having an averaged nominal diameter in the range of 5 μm to 50 μm, a flow rate of said dope being decided such that initial filtration pressure may be 0.1 MPa;
storing said dope in a vessel for two weeks after said first filtration;
performing after the storage a second filtration of said dope with a second filter having the same averaged nominal diameter as said first filter, a flow rate of said dope being decided such that initial filtration pressure may be 0.1 MPa;
using said dope satisfying that when a viscosity of said dope is described as V1 (Pa·s) for said first filtration and V2 (Pa·s) for said second filtration, a viscosity ratio V1/V2 is at least 0.8.

7. An estimation method according to claim 6, wherein said polymer is cellulose acylate.

8. An estimation method according to claim 6, wherein said solvent contains methyl citrate.

9. A solution casting method with use of a dope containing polymer and solvent, comprising steps of:
performing a first filtration of said dope with a first filter having an averaged nominal diameter in the range of 5 μm to 50 μm, a flow rate of said dope being decided such that initial filtration pressure may be 0.1 MPa;
measuring a filtration quantity t1 (m³) of said dope through a unit size of said first filter until filtration pressure becomes 1 MPa;
storing said dope in a vessel for two weeks after said first filtration;
performing after the storage a second filtration of said dope with a second filter having the same averaged nominal diameter as said first filter, a flow rate of said dope being decided such that initial filtration pressure may be 0.1 MPa;
measuring a filtration quantity t2 (m³) of said dope through a unit size of said second filter until filtration pressure becomes 1 MPa; and
casting onto a support said dope satisfying a value t2/t1 is at least 0.5, so as to produce a film.

10. A solution casting method according to claim 9, further comprising a step of performing before said first filtration a third filtration by feeding said dope through a third filter.

11. A solution casting method according to claim 10,
wherein a fourth filtration with use of a fourth filter is performed between said third filtration and said first filtration or after said second filtration;
wherein one of filter materials of said third and fourth filters is filter paper or non-woven cloth and another one is metallic filter material; and
wherein when said averaged nominal diameter is described as P1 (μm) for said third filter and P2 (μm) for said first filter, a condition P1≦0.17×P2 is satisfied.

12. A solution casting method according to claim 11, wherein said fourth filtration is made between said third filtration and said first filtration, and said dope is concentrated between said third filtration and said fourth filtration.

13. A solution casting method according to claim 10, wherein a filter aid is used in at least one of said third filtration and said fourth filtration.

14. A solution casting method according to claim 9, wherein said polymer is cellulose acylate.

15. A solution casting method according to claim 9, wherein said solvent contains methyl citrate.

16. A solution casting method according to claim 9, wherein when a viscosity of said dope is described as V1 (Pa·s) for said first filtration and V2 (Pa·s) for said second filtration, a viscosity ratio V1/V2 is at least 0.8.

17. A solution casting method with use of a dope containing polymer and solvent, comprising steps of:
performing a first filtration of said dope with a first filter having an averaged nominal diameter in the range of 5 μm to 50 μm, a flow rate of said dope being decided such that initial filtration pressure may be 0.1 MPa;
storing said dope in a vessel for two weeks after said first filtration;
performing after the storage a second filtration of said dope with a second filter having the same averaged nominal diameter as said first filter, a flow rate of said dope being decided such that initial filtration pressure may be 0.1 MPa;
casting onto a support said dope satisfying that when a viscosity of said dope is described as V1 (Pa·s) for said first filtration and V2 (Pa·s ) for said second filtration, a viscosity ratio V1/V2 is at least 0.8.

18. A solution casting method according to claim 17, further comprising a step of performing before said first filtration a third filtration by feeding said dope through a third filter.

19. A solution casting method according to claim 18, wherein a fourth filtration with use of a fourth filter is performed between said third filtration and said first filtration or after said second filtration;
wherein one of said third filter and said fourth filter is filter paper or non-woven cloth and another one is metallic filter material; and
wherein when said averaged nominal diameter is described as P1 (μm) for said third filter and P2 (μm) for said first filter, a condition P1≦0.7×P2 is satisfied.

20. A solution casting method according to claim 19, wherein said fourth filtration is made between said third filtration and said first filtration, and said dope is concentrated between said third filtration and said fourth filtration.

21. A solution casting method according to claim 18, wherein a filter aid is used in at least one of said third filtration and said fourth filtration.

22. A solution casting method according to claim 17, wherein said polymer is cellulose acylate.

23. A solution casting method according to claim 17, wherein said solvent contains methyl citrate.
